(19) United States
(12) Patent Application Publication
(10) Pub. No.: US 2005/0114633 A1
(43) Pub. Date: May 26, 2005

(54) Method and system for executing data-relative code within a non data-relative environment

(76) Inventors: Manoj N. Palat, Bangalore (IN); Anil Veliyankara Madom, Bangalore (IN)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/720,096

(22) Filed: Nov. 25, 2003

(30) Foreign Application Priority Data
Nov. 25, 2003 (IN) 10/720096

(51) Int. Cl. G06F 15/00; G06F 7/38

(52) U.S. Cl. 712/226; 712/233

(57) ABSTRACT

A method and system for executing or enabling execution of data-relative code within a non data-relative environment includes locating one or more instances of the use of a data-relative offset within a module of a code segment. A new offset independent of a data segment, is then calculated. The new offset replaces the data offset in the code segment module. The code segment module is copied into a modifiable memory. The new offset replaces the non data-relative offset within the copied code segment module.

### FIELD OF INVENTION

The present invention provides a method and system for executing data-relative code within a non data-relative environment. More particularly, but not exclusively, the present invention provides a method and system for executing code segments with data segment relative branching within an environment with non-consecutive code and data segments.

### BACKGROUND TO THE INVENTION

Shared library modules should have position independent code for their execution. However, some modules in shared libraries might assume consecutive mapping of data and the code segments in virtual memory. This assumption manifests itself in calculations for addresses, such as branch target addresses, within the code segment, being based on, for example, an offset from the global data pointer within the data segment. Some platforms do not, however, map code and data segments consecutively. On such platforms, these libraries cannot be loaded due to the dependency on the relative position of code and data segment mappings.

One solution is to download the sources of these libraries and recompile them so as to make the code free of addresses calculated from data-relative offsets. However, this implies the availability of the sources. Moreover, this would require a significant amount of time and effort.

Another solution is to use the Multiple Address Space (MAS) feature of the operating system. This feature allows consecutive mapping of data and code segments in the address space of a process. However, this feature may not be available on older versions of operating systems.

The problem of code segments with data-relative offsets executing on platforms with non-consecutive mapping of data and code segments can also affect other binary files, such as executables.

It is an object of the present invention to provide a method and system for executing data-relative code within a non data-relative code environment which overcomes the disadvantages of the above solutions, or to at least provide the public with a useful choice.

### SUMMARY OF THE INVENTION

According to a first aspect of the invention there is provided a method of enabling execution of data-relative code within a non data-relative environment, including the steps of:
i) locating one or more instances of the use of a data-relative offset within a module of a code segment;
ii) calculating a new offset independent of data segment; and
iii) replacing the data-relative offset with the new offset in the code segment module.

Preferably, the data-relative offset is used for calculating a target address for a branch instruction within the code segment. The new offset may be calculated relative to the instruction pointer.

When steps (i) to (iii) occur during the runtime of an application which is using the code segment, the code segment module may be executed after the modification in step (iii). Furthermore, the module may be executed on an alternate endian operating system, provided the platform supports execution of alternate endian object files. HP-UX operating system on Intel® Itanium® Processor family (IPF) is an example of a big endian operating system that supports execution of little endian executables.

When steps (i) to (iii) occur while the code segment is not in use, the code segment module may be saved to a non-volatile memory, such as disk, after modification.

The code segment module is from a shared library.

When the code segment is loaded as shareable (within shareable memory) it is preferred that the code segment module is copied into modifiable (or private) memory before step (iii). Alternatively, the code segment may be first loaded as private and writable.

The code segment modules may be .init or .fini sections from a shared library.

The code segment module may be within an executable.

It is preferred that the code segment was compiled using a compiler, such as gcc 2.96, which inserts data-relative code into the compiled binary file. The code segment may be a Linux code segment.

A dynamic loader may be used to perform all the steps of the method.

According to a first aspect of the invention there is provided a system for enabling execution of data-relative code within a non data-relative environment, including:
i) A processor adapted to locate the use of data-relative offsets within a module of a code segment, to calculate a new offset independent of a data segment, and to replace the data-relative offset with the new offset in the code segment module; and
ii) Memory adapted to store the code segment module.

### BRIEF DESCRIPTION OF THE DRAWINGS

Embodiments of the invention will now be described, by way of example only, with reference to the accompanying drawings in which:

FIG. 1: shows a diagram illustrating a preferred embodiment of the invention.

FIG. 2: shows a diagram illustrating a first method for calculating an address based on a non data-relative offset.

FIG. 3: shows a flow diagram illustrating an embodiment of the invention.

FIG. 4: shows a diagram illustrating an embodiment of the invention.

FIG. 5: shows a diagram illustrating an embodiment of the invention.

FIG. 6: shows a diagram illustrating a second method for calculating an address based on a non data-relative offset.

### DETAILED DESCRIPTION OF THE PREFERRED EMBODIMENTS

The present invention relates to a method and system for executing data-relative code in non data-relative environments. The invention will be described in relation to the HP-UX platform but could be used in relation to other platforms with appropriate modifications.

Data-relative code is a code segment which contains a calculation for an offset which is dependent on a pointer within data segment. The pointer that is usually used to calculate a data-relative offset is the Global data pointer (GP). The Global data pointer is the address of a reference location in a load module's data segment, usually kept in a specified general register during execution. Each load module has a single such reference point, typically near the middle of the load module's linkage table. Applications use this pointer as a base register to access linkage table entries, and data that is local to the load module. A load module is an object file that can be loaded and executed; mainly executables and shared libraries.

The data-relative offset is typically used to calculate a target address for a branch instruction. On a non data-relative environment the target address will be an invalid address, with high probability of being outside the address space of the given shared library.

Data-relative environments are platforms which always consecutively map the code and data segments in memory, thus ensuring that the address calculation is always valid.

Non data-relative environments are those platforms which cannot enforce the consecutive mapping in memory of code and data segments. Consequently, calculations for addresses within the code segment using an offset which is dependent on a pointer within the data segment are almost always invalid. HP-UX on the Intel® Itanium® Processor family (IPF) platform is such an environment.

In a shared library or executable, segments are runtime logical units and sections are link time logical units. The code segment of a shared library or executable contains different sections like, init, fini, text etc. containing executable code. The data segment contains mainly the data section.

A library is an object file.

An executable is a collection of object files which have been linked together using a link editor.

When an executable links a static library object file the modules within the static library are resolved into the executable. This means that the executable does not require outside files to use those modules.

When an executable links a shared library object file the modules within the shared library are not resolved into the executable. This means that whenever the executable is executed, a program called a dynamic loader is used to bind the symbols within the executable to modules from a copy of the shared library object file.

An advantage of compiling a library as a shared library is that one copy of the library loaded into memory may be used by many executables.

An object file is obtained by using a compiler to compile a source code file.

It will be appreciated that the source code can be in a variant of C or any other language.

The compiler can be a c compiler such as gcc 2.96, or any other compiler for a high-level language.

The steps below illustrate how an executable which uses a shared library will be typically loaded and executed by a dynamic loader:
a) The kernel loads the executable and the dynamic loader into memory and transfers control to the dynamic loader.
b) The dynamic loader loads all the shared libraries that the executable links with (with their text segments shared in the default case).
c) The dynamic loader executes the code in the .init section of each library and finally that of the executable.
d) The dynamic loader transfers control to the executable.
e) The executable finishes execution.
f) Control goes back to the loader and code in .fini section of each library and that of the executable is executed.
g) Loader exits.

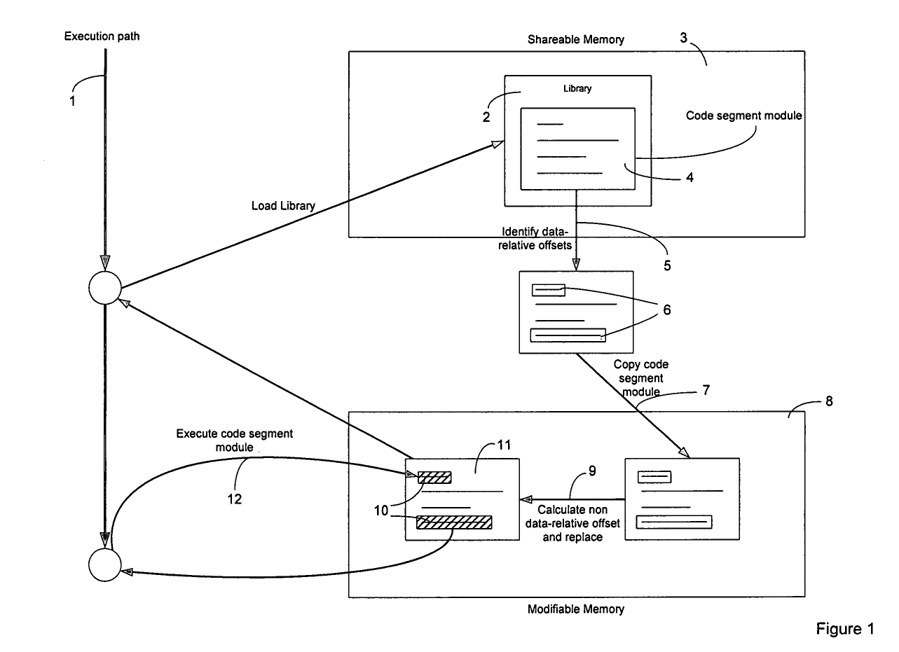

The method of the invention will now be described with reference to FIG. 1.

During execution 1 of an executable a shared library 2 is loaded by a dynamic loader. In this example the library 2 is already loaded into memory 3. However, the shared library 2 may need to be loaded into memory from disk.

As the library is a shared library, in the default case, its code segment is mapped into to the memory as shareable 3 by the dynamic loader so that different executables may share the same copy of the library.

If a shared library is loaded as shareable by the dynamic loader, different executables may share the same copy of the library. In this case any modification directly in the code segment of the library is not possible.

A module 4 from the code segment of the library is extracted and searched 5 for data-relative offsets 6.

In one embodiment of the invention when the data-relative offset is used by a branch instruction, the method of locating data-relative address is performed by first checking the target address of each branch instruction and backtracing in the code to find where the target register is filled. The next step is to establish whether the address is calculated based on the data segment. In this example, a check as to whether register r1 is used as register r1 contains the data pointer. If the target address is calculated by adding an offset to register r1, then the target address is calculated using a data-relative offset.

If any data-relative offsets are located, the code segment module is copied 7 to modifiable memory 8 private to the executable. The code segment module must be copied because the modification in the shared code module will affect the execution of other processes using the shared library.

It is possible to load the code segment of a shared library as private and writable into memory. However, this is not a preferred method as no other process can use this copy of the shared library. This will lead to an increased use of system resources to maintain multiple copies of the same shared library in memory.

In step 9 non data-relative offsets 10 are calculated for each of the data-relative offsets and these new offsets replace the data-relative offsets in the copied code segment module 11.

In this example, the new offset is calculated to be relative to the Instruction Pointer (IP). The IP is a special register which holds the runtime address of the current instruction. Any instruction that reads the value of the IP will get the instruction's runtime address in memory.

When the code segment module is to be executed the modified code segment module 11 is executed 12 instead of the code segment module 4 within the shared code segment.

In an alternative embodiment of the invention, the code segment module is modified immediately prior to execution.

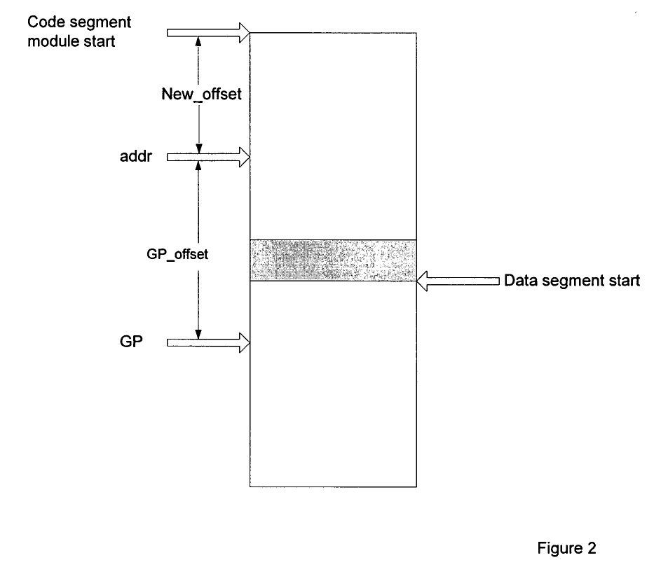

FIG. 2 shows a preferred method for calculating an absolute runtime address to replace the data-relative offset in a shared library.

In FIG. 2 the data-relative offset is used in the target address of a branch instruction (not shown).

The branch target address is based on GP. GP is at a constant offset from the data segment start.

The original calculation for the target address using the data-relative offset and the branch instruction will be as follows:
addr=GP+GP_offset
branch_to addr.

As shown in FIG. 2, this works as long as text segment and data segment are mapped consecutively. However if the text and data segments are not mapped consecutively, the address calculation must be made independent of GP.

The value “New_offset” does not depend on the mapping address of data segment. New_offset may be calculated as follows:
New_offset=(GP+GP_offset)−text_segment_start;

This calculation is done using the values available at link time (GP as well as “text_segment_start” shown above are link time addresses).

As the library is a shared library, the runtime text segment start address will be different. Hence the actual runtime branch target address is calculated by adding the new offset to the runtime text start as shown below:
new_target=text_runtime_start+New_offset
branch_to new_target;

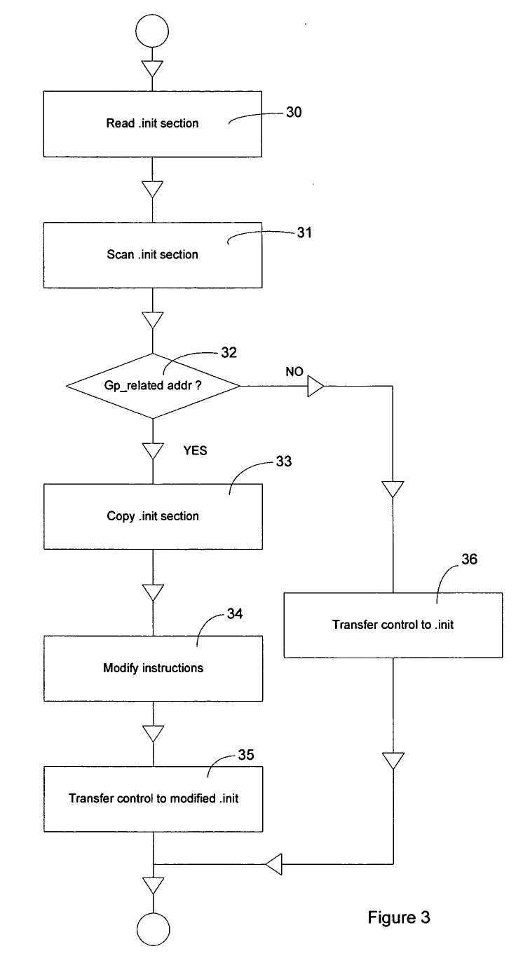

Referring to FIG. 3, a possible application of the method will be described.

Library object files contain two sections of code called .init and .fini. These sections are normally inserted by the compiler when the library source code file is compiled. The .init section contains code that executes when the library is being loaded and before any of the application programming interfaces (API) within the library are called. The .init section typically contains initialization routines for the library. The .fini section contains code that will be executed when the library is being unloaded and typically contains cleanup routines.

Invalid target addresses present inside these sections will cause a failure in the loading and/or unloading stage. This will lead to the failure of entire loading process and the execution failure of applications dependent on this library.

The code segment modules of a shared library will not generally contain data-relative branching because a shared library is normally compiled using the—fPIC option (force position independent code) and the address pointers within the code segment modules are made data segment independent.

However, the compiler gcc-2.96 inserts data-relative branch address calculations in the init and .fini sections regardless of whether the library was compiled with the—fPIC option. This has been changed within gcc-3.0 and later versions. Unfortunately, most of the Linux applications currently available on the Internet are compiled using gcc-2.96.

To render the .init and .fini sections non data-relative the recompilation of the entire library with gcc-3.0, or above, is necessary. In order to do this the source code for the library is required. The source code may not always be available and the recompilation of all affected libraries is a time and effort consuming process.

It will be appreciated that other compilers may have this same behavior.

An implementation of the method to solve this problem in relation to the .init section will now be described.

When the library is loaded the .init section is read in step 30 and scanned in step 31 for offsets, used to calculate addresses, that are data-relative. Step 32 determines if any data-relative offsets are located.

If there are data-relative offsets the init section is copied in step 33 into modifiable memory. In step 34 a new offset independent of the data segment pointer is calculated and the instruction using the data-relative offset is modified to use the new offset. In step 35 control is passed to the modified init section to execute.

If no data-relative offsets were located the original init would be given control in step 36.

A pseudo-algorithm illustrating this implementation is given below:

While loading the shared library
begin

if (init_section_has_data_segment_relative_branches ( ))
begin

map a new area with read, write and execute permission
copy the contents of .init section to this area
backtrace the branches to get the data segment relative offset
replace the current branch target calculation instructions
with no-ops calculate the absolute virtual address taking the link
time and run time text segment base
encode this address in a new instruction
add this instruction before the branch instruction
transfer control to the beginning of this code segment
once it returns, deallocate this area

end
continue with the loading process

end

An implementation of the method to solve this problem in relation to the .fini section would be similar except that the loader will be proceeding for unloading once the modified section is executed. Also, the pseudo-code covers only an outline of the algorithm. In actual implementation, the backtracing step would have already completed at the time of the check (i.e. when the loader checks whether an .init section has data-relative branches) and this information will be reused in the backtracing step.

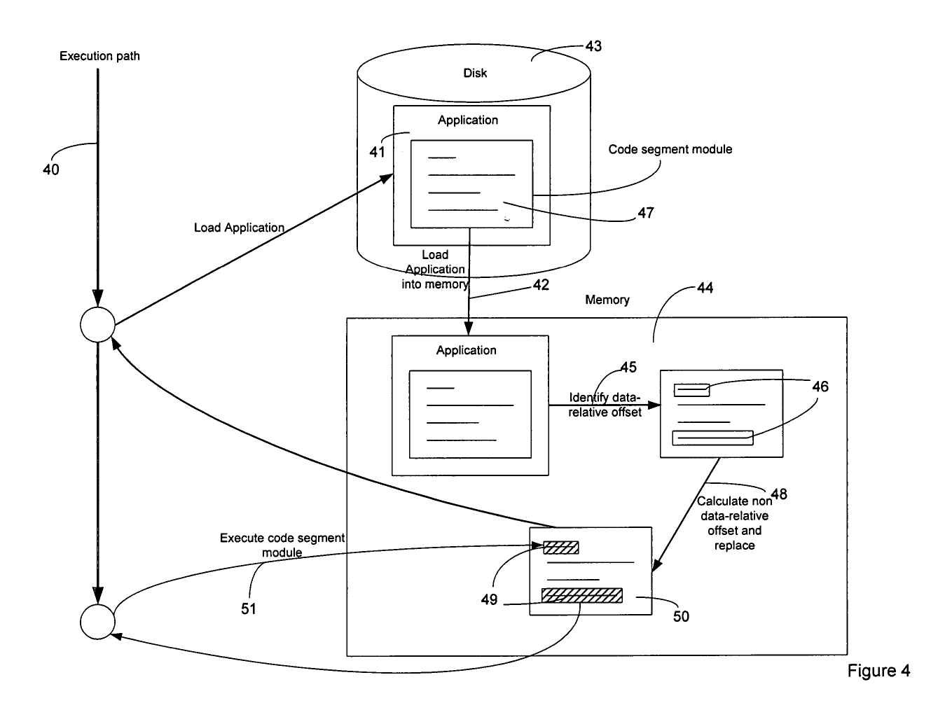

Referring to FIG. 4, a further embodiment of the method will be described.

This embodiment is for the scenario when the data-relative offsets are located within an executable rather than a shared library used by the executable and the executable is loaded into private memory.

This scenario is not applicable for some versions of HP-UX as the executable's code segment on these platforms is mapped as shareable. Hence, it is not possible to modify the code segment at runtime. In such a case, the method described in FIG. 1 can be used with appropriate modifications.

During runtime 40 of an application 41 (an executable) it is loaded 42 from disk 43 into memory 44.

In step 45 data-relative code 46 is identified within a module of the code segment 47 of the application 41.

In step 48 runtime offsets 49 are calculated and replace the data-relative offsets.

As the original code segment module has been modified 50 when it is executed 51 the runtime offsets 49 are used.

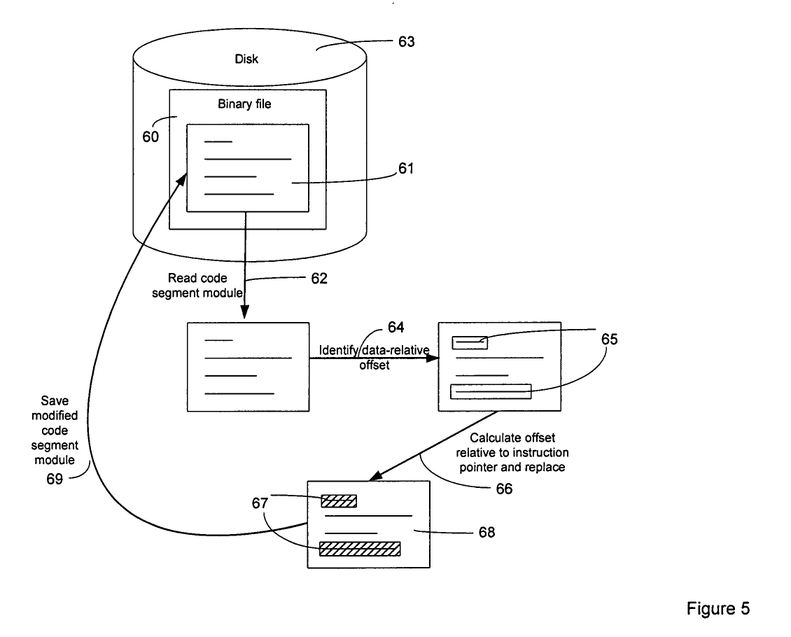

Referring to FIG. 5, a further embodiment of the method will be described.

The method of the invention may be used to replace the data-relative offsets in a static copy of a binary file 60, such as an executable or shared library on a storage device.

A module from the code segment 61 from the binary file 60 is read 62 from non-volatile memory 63 such as a disk.

The code segment module is scanned 64 for data-relative offsets 65. In step 66 offsets relative to the instruction pointer are calculated and replace the data-relative offsets.

The modified code segment module 67 is saved 68 back within the binary file 60 on non-volatile memory 63.

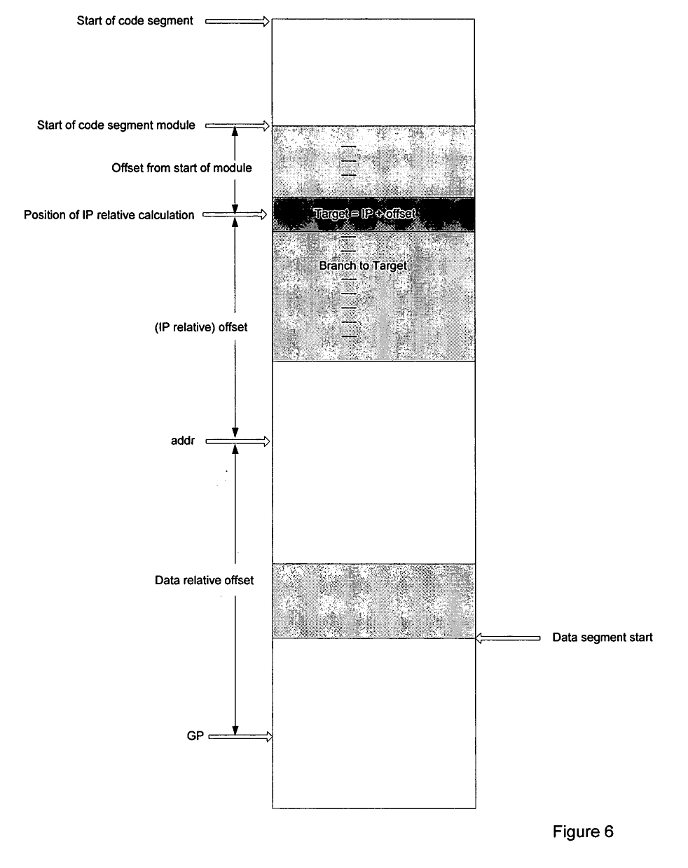

FIG. 6 shows how offsets relative to the start of the code segment can be calculated for .init or .fini sections within a shared library.

It will be appreciated that the calculations may also be used with slight modification for other modules from a code segment within a shared library or an executable.

To illustrate this, a pseudo-algorithm, to statically modify the libraries that have .init/.fini sections with data relative branch address calculations is as follows:
1. read the .init/.fini section of the shared library/executable.
2. if data-relative offset found
   a) calculate link time addr from data-relative offset using the formula
      link_{—}time_{—}addr=link_{—}time_{—}gp+gp_{—}relative_{—}offset
   b) from link time_addr calculate the instruction pointer (IP) relative offset of the intended branch target address using the formula
      ip_{—}relative_{—}offset=link_{—}time_{—}addr−(link_{—}time_{—}init_{—}start+position_{—}of_{—}IP)
   wherein link_time_init_start is the link time address of the .init (or .fini) section and position_of_IP is the offset within the init (or .fini) section (relative to the start of the .init/.fini section) where the instructions to add IP value and ip_relative_offset need to be inserted.
   c) modify the code in the .init/.fini section to replace the GP relative address calculation instructions with IP relative address calculation instructions in the init code.
   d) Write back to the disk image.

The approach here is different from the one used in the runtime model. The runtime method uses values like the runtime text segment start address, which can be used to find the runtime absolute branch target address directly. These values are known only at run time and the static method cannot predict it. So it has to insert the IP relative address calculation instructions. However, the static method can be used in runtime model also because all the information required for calculating the IP relative offset is available at runtime.

A preferred implementation of the invention is as part of a Linux Runtime Environment (LRE) product. LRE provides a transparent layer for the execution of little-endian IPF Linux binaries over big-endian HPUX IPF. LRE has a modified libc, which provides a thin layer of interface for the system calls. Major functionalities of this interface layer include marshalling parameters, processing endianness differences, and mapping system call error numbers.

A modified Linux dynamic loader is provided as part of this product for loading the dependent shared libraries which themselves are little-endian.

The loader is further modified to implement the method of the invention. The modified dynamic loader will detect the data-relative branch target addresses as a first step. Once this is detected, the loader will emit correction code which essentially patches the branch target addresses with the correct address and reroute the control over to new code. Once the control returns from this new code, processing resumes normally facilitating seamless execution of modules. This implementation can be carried out for little-endian Linux libraries being loaded on big-endian HPUX platform while running over LRE on the IPF platform.

An advantage of the invention is that it provides savings in terms of time and effort. Currently used solutions, involving the downloading of shared library sources and recompilation so as to make the code totally free from the assumption of consecutive mapping of data and code segments, are inconvenient. The invention saves the user time and effort in downloading and recompilation as it involves the binary and provides a transparent solution.

A further advantage of the invention is that it is self-sufficient because it does not depend on any operating system support. HP-UX version 11.23 provides for the mapping of data segments and code segments consecutively. However, on systems with versions earlier than HP-UX 11.23 affected libraries will not work. The invention provides a uniform solution for this issue regardless of existence of operating system support.

A further advantage of one implementation of the invention is that it does not modify the existing libraries since it does the remapping and modifications dynamically. In addition another implementation of the invention provides the functionality to statically modify the shared libraries and executables.

A further advantage of the invention is that dynamic relocation of position-dependent branches embedded in position independent code enables seamless execution of the code.

It will be appreciated that the issue of executing data-relative code within non-data-relative code environments is not specific to any architecture. It can occur if the following conditions are met:
i. The compiler assumes the relative position of text and data segments in virtual memory and generates code with data relative branch address calculations; and
ii. The above assumption is not valid on the architecture/OS.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details representative apparatus and method, and illustrative examples shown and described. Accordingly, departures may be made from such details without departure from the spirit or scope of applicant's general inventive concept.

1. A method of enabling execution of data-relative code within a non data-relative environment, including the steps of:
i) locating one or more instances of the use of a data-relative offset within a module of a code segment;
ii) calculating a new offset independent of a data segment; and
iii) replacing the data-relative offset with the new offset in the code segment module.

2. A method as claimed in claim 1 wherein the data-relative offset is used for computing the target address of a branch instruction.

3. A method as claimed in claim 2 wherein the new offset is relative to the instruction pointer.

4. A method as claimed in claim 3 wherein the new offset is calculated using the formula:
new_{—}offset=link_{—}time_{—}data_{—}address+data_{—}relative_{—}offset−(link_{—}time_{—}module_{—}start+instruction_{—}pointer_{—}offset);
wherein:
new_offset=the new offset;
link_time_data_address=the data address during link time;
data_relative_offset=the address relative to the data address;
link_time_module_start=the address of the start of the module of the code segment during link time; and
instruction_pointer_offset=the offset, relative to the start of the code segment module, of the instruction that calculates the new address using the instruction pointer (IP).

5. A method as claimed in claim 3 wherein steps (i) to (iii) occur during runtime of an application using the code segment.

6. A method as claimed in claim 5, including the step of:
iv) executing the modified code segment module.

7. A method as claimed in claim 6 wherein the code segment module is executed on an HP-UX platform.

8. A method as claimed in claim 6 wherein the code segment is compiled for a little-endian system and the code segment module is executed on a big-endian system.

9. A method as claimed in claim 6 wherein the code segment module is executed on a non-native platform.

10. A method as claimed in claim 5 wherein the new offset is an absolute runtime address.

11. A method as claimed in claim 10 wherein the absolute runtime address is calculated using the formula:
runtime_{—}addr=link_{—}time_{—}data_{—}addr+data_{—}relative_{—}offset−link_{—}time_{—}code_{—}segment_{—}start+runtime_{—}code_{—}segment_{—}start;
wherein:
runtime_addr=the absolute runtime address;
link_time_data_addr=the data address during link time;
data_relative_offset=the address relative to the data address;
link_time_code_segment_start=the address of the start of the code segment during link time; and
run_time_code_segment_start=the absolute address of the start of the code segment during runtime.

12. A method as claimed in claim 2 wherein steps (i) to (iii) occur outside of the runtime of the application using the code segment.

13. A method as claimed in claim 12, including the step of:
v) saving the modified code segment module to non-volatile memory.

14. A method as claimed in claim 1 wherein the code segment module is within a shared library.

15. A method as claimed in claim 14, including the step of:
vi) copying the code segment module to modifiable memory;
wherein step (vi) occurs before step (iii) and wherein step (iii) the data-relative offset is replaced in the copied code segment module.

16. A method as claimed in claim 15, including the step of:
vii) allocating the modifiable memory read, write and execute permissions;
wherein step (vii) occurs before step (vi).

17. A method as claimed in claim 14 wherein the code segment within the shared library is mapped as writable.

18. A method as claimed in claim 14 wherein the code segment module is one selected from the set of an init section from the shared library and a .fini section from the shared library.

19. A method as claimed in claim 1 wherein the code segment is within an application.

20. A method as claimed in claim 1 wherein the code segment was compiled using a compiler which inserts code that uses data-relative offsets.

21. A method as claimed in claim 20 wherein the code segment was compiled using gcc 2.96.

22. A method as claimed in claim 1 wherein a dynamic loader performs all the steps.

23. A method as claimed in claim 2 wherein the data-relative offset is located in step (i) by backtracing the target register of the branch instruction.

24. A method as claimed in claim 1 wherein the code segment is a Linux code segment.

25. A system for enabling execution of data-relative code within a non data-relative environment, including:
i) A processor adapted to locate the use of data-relative offsets within a module of a code segment, to calculate a new offset independent of a data segment, and to replace the data-relative offset with the new offset in the code segment module; and
ii) Memory adapted to store the code segment module.

26. A system as claimed in claim 25 wherein the data-relative offset is used for computing the target address of a branch instruction.

27. A system as claimed in claim 26 wherein the new offset is relative to the instruction pointer.

28. A system as claimed in claim 27 wherein the new offset is calculated using the formula:
new_{—}offset=link_{—}time_{—}data_{—}address+data_{—}relative_{—}offset−(link_{—}time_{—}module_{—}start+instruction_{—}pointer_{—}offset);
wherein:
new_offset=the new offset;
link_time_data_address=the data address during link time;
data_relative_offset=the address relative to the data address;
link_time_module_start=the address of the start of the module of the code segment during link time; and
instruction_pointer_offset=the offset, relative to the start of the code segment module, of the instruction that calculates the new address using the instruction pointer (IP).

29. A system as claimed in claim 25 wherein the processor is further adapted to execute an application using the modified code segment module.

30. A system as claimed in claim 29 wherein the new offset is an absolute runtime address.

31. A system as claimed in claim 30 wherein the absolute runtime address is calculated using the formula:
runtime_{—}addr=link_{—}time_{—}data_{—}addr+data_{—}relative_{—}offset−link_{—}time_{—}code_{—}segment_{—}start+runtime_{—}code_{—}segment_{—}start;
wherein:
runtime_addr=the absolute runtime address;
link_time_data_addr=the data address during link time;
data_relative_offset=the address relative to the data address;
link_time_code_segment_start=the address of the start of the code segment during link time; and
run_time_code_segment_start=the absolute address of the start of the code segment during runtime.

32. A system as claimed in claim 25, including:
iii) non-volatile memory adapted to store the modified code segment module.

33. A system as claimed in claim 25 wherein the code segment is within a shared library.

34. A system as claimed in claim 33, including:
iv) modifiable memory adapted to stored the code segment module; and wherein the processor is further adapted to copy the code segment module to the modifiable memory and wherein the data-relative offset is replaced in the copied code segment module.

35. A system as claimed in claim 34 wherein the processor is further adapted to allocate the modifiable memory read, write and execute permissions.

36. A system as claimed in claim 33 wherein the code segment module is one selected from the set of an .init section from the shared library and a .fini section from the shared library.

37. A system as claimed in claim 25 wherein the code segment is within an application.

38. A system as claimed in claim 25 wherein the code segment was compiled using a compiler which inserts code that uses data-relative offsets.

39. A system as claimed in claim 38 wherein the code segment was compiled using gcc 2.96.

40. A system as claimed in claim 25 wherein the code segment is a Linux code segment.

41. A system as claimed in claim 29 wherein the code segment module is executed on an HP-UX platform.

42. A system as claimed in claim 29 wherein the code segment is compiled for a little-endian system and the code segment module is executed on a big-endian system.

43. A system as claimed in claim 29 wherein the code segment module is executed on a non-native platform.

44. A code segment module modified by the method of claim 1.

45. A binary file containing a code segment module modified by the method of claim 1.

46. Software for effecting the method of claim 1.

47. Storage media including the software as claimed in claim 46.

48. A computer system for effecting the method of claim 1.

49. A memory storing the software of claim 46.
